(19) United States
(12) Patent Application Publication
(10) Pub. No.: US 2012/0234777 A1
(43) Pub. Date: Sep. 20, 2012

(54) BICYCLE SECURITY APPARATUS

(76) Inventor: HUNG-JU CHEN, TAICHUNG CITY (TW)

(21) Appl. No.: 13/488,448

(22) Filed: Jun. 5, 2012

Related U.S. Application Data
(63) Continuation-in-part of application No. 12/783,000, filed on May 19, 2010.

(51) Int. Cl. E05B 73/00

(52) U.S. Cl. 211/5

(57) ABSTRACT

A bicycle security apparatus includes a housing standing on a supporting plane (ground), at least one drive device disposed in the housing, at least one latch connected to the drive device and a control unit mounted onto the housing. The latch is reciprocally rotated by the drive device to achieve the locked condition and the unlocked condition. The control unit can recognize the identity of the operator such that a man with fraudulent intentions can not steal a bicycle from the bicycle security apparatus.

### CROSS-REFERENCE TO RELATED APPLICATION

This application is a Continuation-In-Part of application Ser. No. 12/783,000, filed May 19, 2010, and entitled “AUTOMATIC BIKE LOCKING CHARGING MACHINE”, now pending, the contents of which are incorporated herein by reference.

### BACKGROUND OF THE INVENTION

1. Field of the Invention

The present invention relates to a bicycle security apparatus, and more particularly to a bicycle security apparatus that locks the main frame of the bicycle and provides a charge function before unlocking the locked bicycle.

2. Description of Related Art

A conventional bicycle parking device in accordance with the prior art shown in FIG. 8 comprises two lateral frames (50) and multiple pairs of positioning frames (60) secured on the two lateral frames (50). When parking the bicycle, the front wheel (70) of the bicycle is sandwiched between a corresponding one of the multiple pairs of positioning frames (60). However, the conventional bicycle parking device provides no anti-theft function unless the bicycle rider prepares a lock by himself/herself and locks the front wheel (70) on the positioning frames (60). It is very inconvenient and the key of the bicycle lock may be lost. As a result, the bicycle ride may not ride the bicycle home when the key is lost. In addition, only the front wheel (70) locked on the positioning frames (60) is very dangerous because the front wheel (70) is easily detached from the main frame of the bicycle. Sometimes, there is only the front wheel (70) locked on the positioning frame (60), and others are gone when taking back the bicycle. It will make you so bad.

In view of this, some bicycle security systems are marketed, such as U.S. Pat. No. 5,278,538 to Ainsworth et al. they use three lock units to lock the front wheel, the main frame and the rear wheel of the bicycle at the same time for providing an anti-theft function. The three lock units are secured on the base portion of Ainsworth et al. and the relative positions of the three lock units are fixed. However, the bicycles have different standards such that the use scope the bicycle security system of Ainsworth et al. is limited. In addition, the bicycle security system of Ainsworth et al. has a meter head portion and a base portion connected to a lower end of the meter head portion, and the base portion has a length equal to that of the bicycle such that the cost of the bicycle security system of Ainsworth et al. is very high because it needs a lot of material to form the base portion.

The present invention has arisen to mitigate and/or obviate the disadvantages of the conventional apparatuses for parking the bicycles.

### SUMMARY OF THE INVENTION

The main objective of the present invention is to provide an improved bicycle security apparatus that locks the main frame of the bicycle and provides a charge function before unlocking the locked bicycle.

To achieve the objective, the bicycle security apparatus in accordance with the present invention comprises a housing standing on a supporting plane. The housing includes a panel formed on a front side thereof and two side plates respectively connected to the panel. At least one of the two side plates has an opening defined therein and a hook secured thereon. An opening is defined in the side plate where the hook is secured. The hook has a distal end extending toward the opening. At least one drive device is disposed in the housing and corresponds to the at least one opening. At least one latch is connected to the at least one drive device and the at least one latch is reciprocally driven by the at least one drive device, wherein the latch is received in the housing when the bicycle security apparatus is in an unlocked condition and the latch facing the distal end of the hook when the bicycle security apparatus is in a locked condition. A control unit is mounted onto the panel. The control unit includes a central process unit mounted onto the interior of the panel. A slot device, a card reader and a fingerprint recognize device are respectively mounted onto the panel and electrically connected to the central process unit, wherein the slot device is provided for user to insert coin(s) before take bake his/her bicycle and the card reader is provided to read the personal data from a card, and the card reader and the fingerprint recognize device are provided to recognize the person who wants to take back his/her bicycle. An input device is disposed on the panel for user to input the pass word(s) of his/her card for ensuring the identity of the card owner.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle security apparatus in accordance with the present invention;

FIG. 2 is an exploded perspective view of a bicycle security apparatus in FIG. 1;

FIG. 3 is a partially cross-sectional view of the bicycle security apparatus in FIG. 1;

FIG. 4 is an operational view of the bicycle security apparatus in accordance with the present invention;

FIG. 5 is a first schematic view of the bicycle security apparatus in accordance with the present invention;

FIG. 6 is a second schematic view of the bicycle security apparatus in accordance with the present invention;

FIG. 7 is a side plan view of a second embodiment of the bicycle security apparatus in accordance with the present invention; and

FIG. 8 is a perspective view of a conventional bicycle parking device in accordance with the prior art.

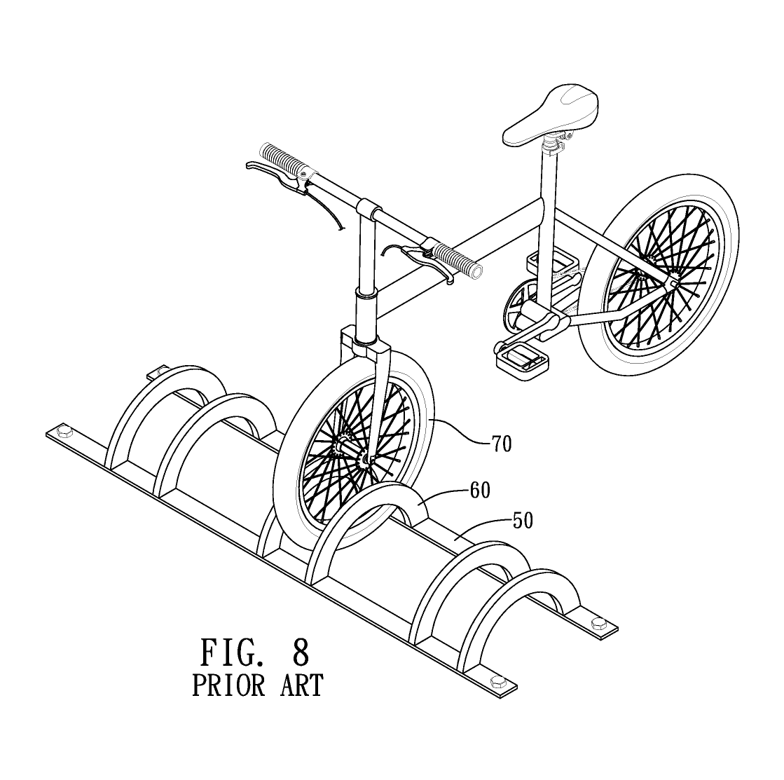

### DETAILED DESCRIPTION OF THE INVENTION

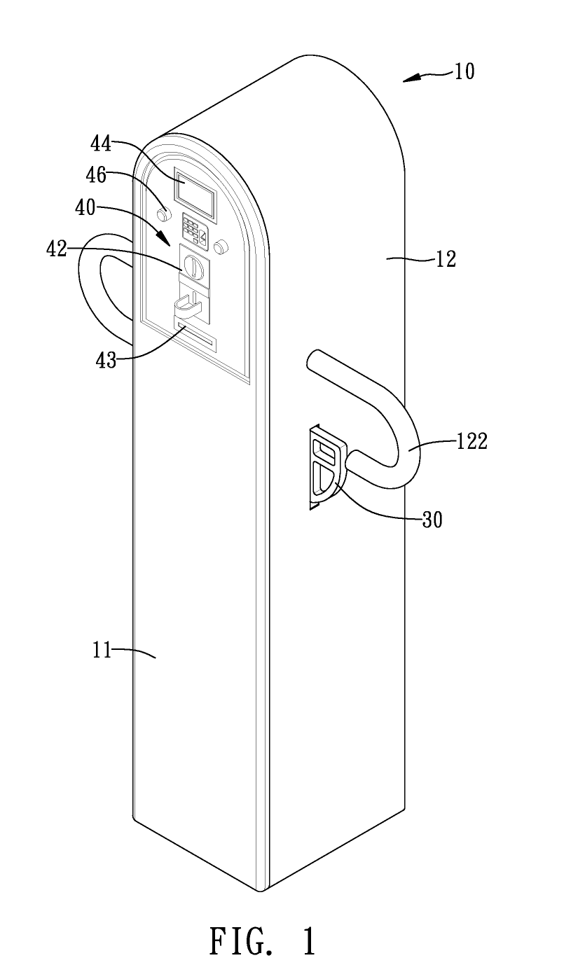

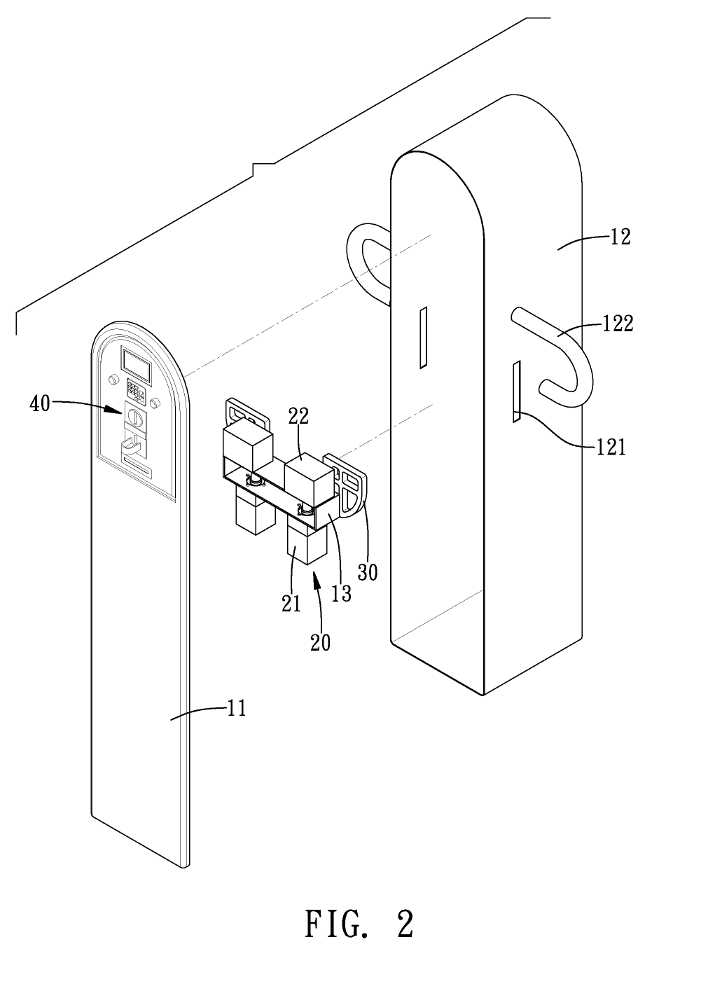

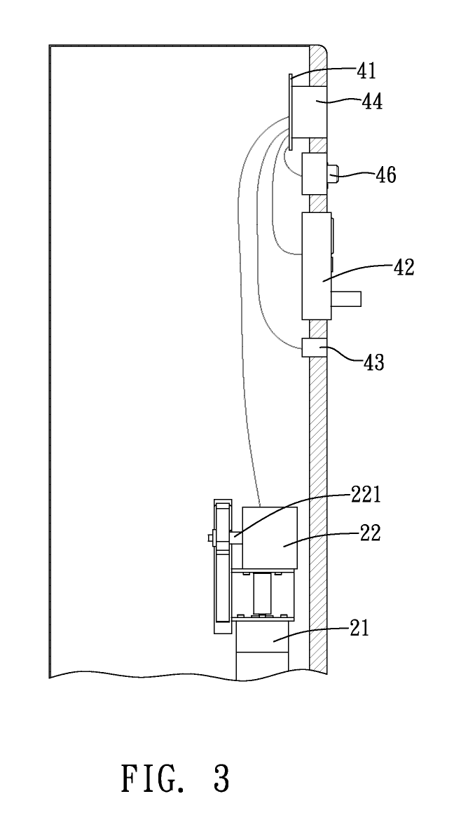

Referring to the drawings and initially to FIGS. 1-3, a bicycle security apparatus in accordance with the present invention comprises a housing (10) standing on a supporting plane (ground), at least one drive device (20) disposed in the housing (10), at least one latch (30) connected to the drive device (20) and a control unit (40) mounted onto the housing (10). In the preferred embodiment of the present invention, there are two drive devices (20) respectively disposed in the housing (10) and two latches (30) respectively connected to a corresponding one of the two drive devices (20). The two latches (30) are received in the housing (10) when the bicycle security apparatus in accordance with the present invention is in an unlock condition.

The housing (10) includes a panel (11) formed on a front side thereof and two side plates (12) respectively connected to the panel (11). At least one of the two side plates (12) has an opening (121) defined therein and a hook (122) secured thereon. In the preferred embodiment of the present invention, each side plate (12) has an opening (121) defined therein and a hook (122) secured thereon wherein the two openings (121) horizontally correspond to each other and each hook (122) has a free end extending toward a corresponding one of the two openings (121). A partition (13) is horizontally mounted in the housing (10).

The two drive devices (20) are respectively mounted onto the partition (13). Each drive device (20) laterally corresponds to one of the two openings (121). The drive device (20) includes a motor (21) secured on the partition (13) and a reducer (22) longitudinally connected to the motor (21). The reducer (22) has a shaft (221) extending therefrom for mounting and reciprocally driving the latch (30) within 90 degrees. In the preferred embodiment on the present invention, the latch (30) is sector-shaped for closing the opening (121) and a distance between a distal end of the hook (122) is slightly greater than a radius of the latch (30). A man with fraudulent intentions can not damage the drive device (20) and the control unit (40) by inserting a stick into the housing (10) through the opening (121).

The control unit (40) includes a central process unit (41) mounted onto the interior of the panel (11). A slot device (42), a card reader (43) and a fingerprint recognize device (44) are respectively mounted onto the panel (11) and electrically connected to the central process unit (41). The slot device (42) is provided for user to insert coin(s) before take bake his/her bicycle and the card reader (43) is provided to read the personal data from the card, such as a credit card, and charge the parking fee. The card reader (43) and the fingerprint recognize device (44) is provided to recognize the person who wants to take back his/her bicycle. After recognize step, anyone can not take other's bicycle, deliberately. An input device (45) and two selectors (46) are respectively disposed on the panel (11) and electrically connected to the central process unit (41). For example, the input device (45) is provided for user to input the pass word(s) of his/her card for ensuring the identity of the card owner, and the selector (46) is provider for user to select a corresponding one of the two drive devices (20) which he/she wants to operate and lock his/her bicycle.

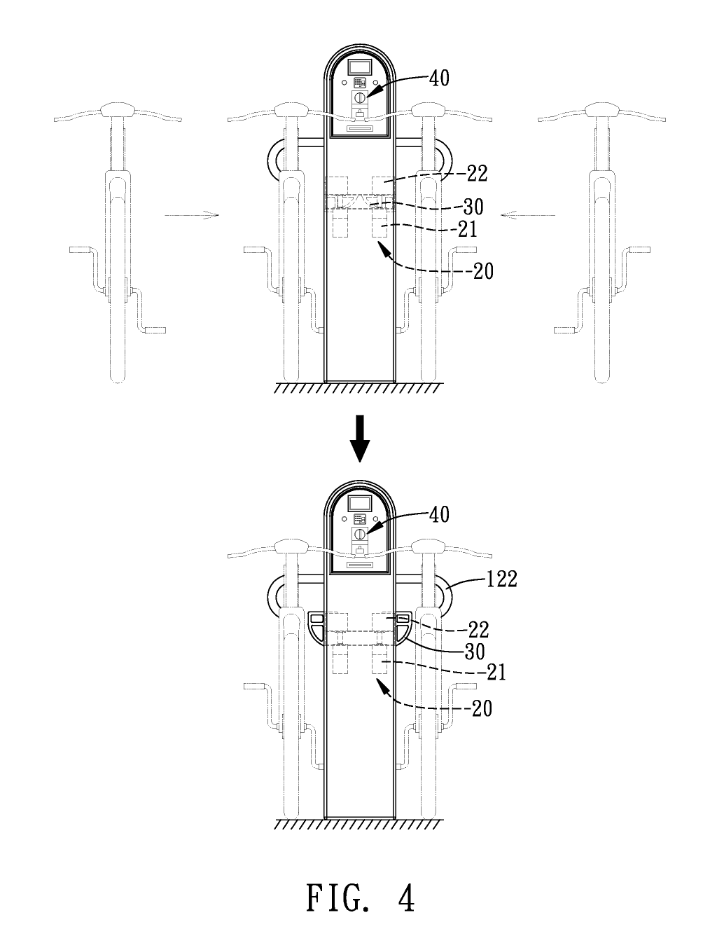

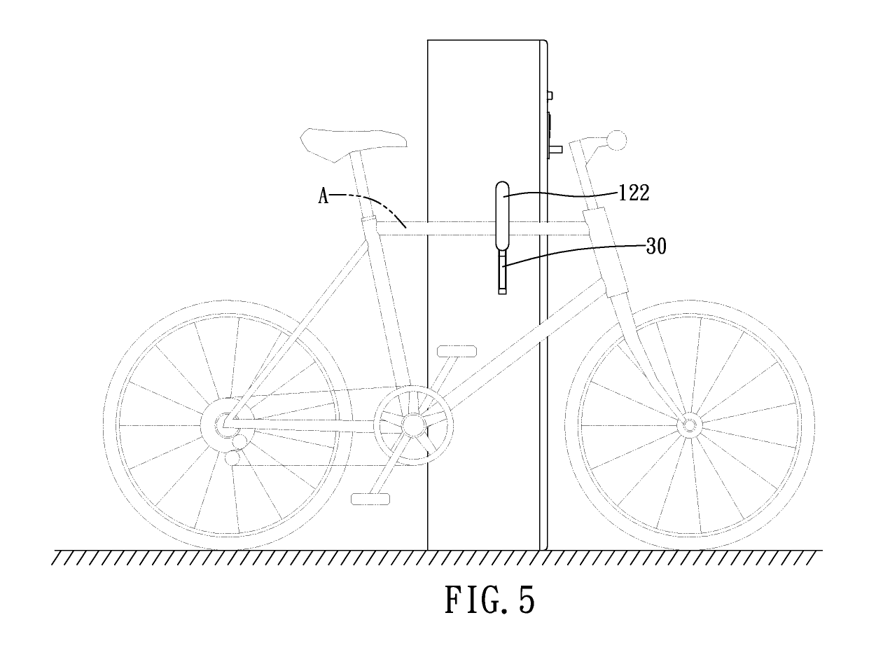

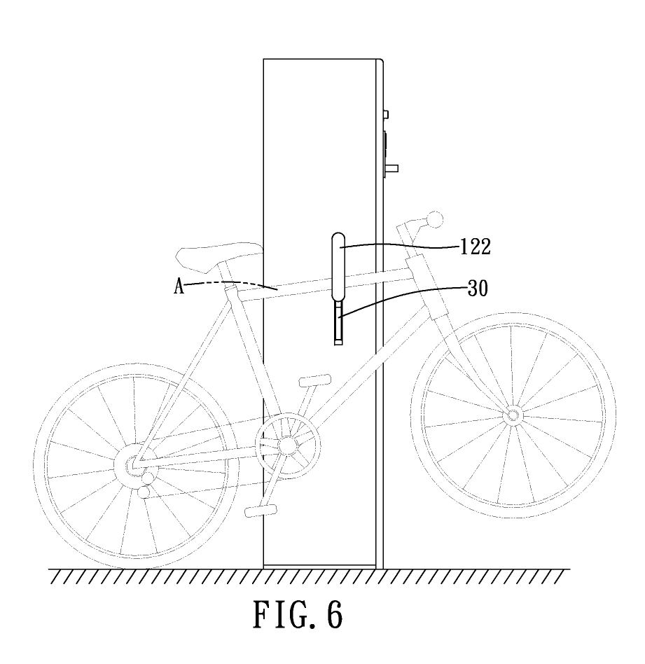

With reference to FIGS. 1 and 4 to 5, when using the bicycle security apparatus in accordance with the present invention to park and lock a bicycle, the operator makes the top tube (A) of the bicycle within a hook (122) which he/she selects by a corresponding one of the two selectors (46). Next, the operator needs to ensure his/her identity by insert a card to the card reader (43) or press the fingerprint recognize device (44) by his/her fingertip such that his/her unique personal data/fingerprint is saved in the central process unit (41). Lastly, the central process unit (41) sequentially operates the motor (21) and the reducer (22) to upwardly rotate the latch (30) and the bicycle is locked when the periphery of the latch (30) faces a distal end of the hook (122). With reference to FIG. 6, as well known, different bicycles have different standards. The user only need to slightly lift a child's bicycle, which has a lower main frame, to make the top tube (A) of the bicycle within the hook (122) and the child's bicycle with a lower main frame can be locked as well as an ordinary bicycle. As a result, the bicycle security apparatus in accordance with the present invention has a use scope greater than that of the conventional bicycle security system, such as U.S. Pat. No. 5,278,538.

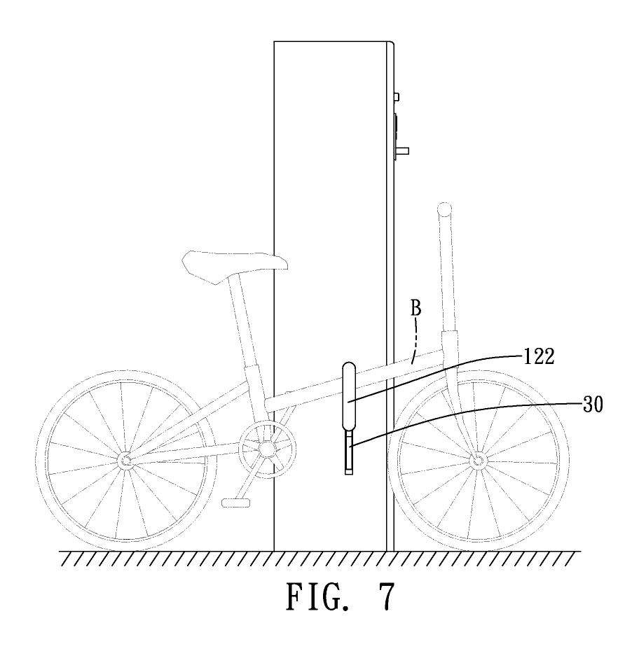

With reference to FIG. 7, the bicycle security apparatus in accordance with the present invention also can be provided to lock a down tube (B) of a bicycle when the partition (13) with the drive devices (20) and the latches (30) is mounted onto a lower portion of the housing (10). As usual, the down tube (B) is inclined relative to the support plane such that the operator only needs to move the bicycle forward/backward the down tube (B) can be easily situated with the hook (122). As a result, even a child can easily park and locked his/her bicycle without lifting his/her bicycle.

When unlocking the bicycle, the rider needs to ensure his/her identity by the card reader (43) or the fingerprint recognize device (44) and the central process unit (41) will calculate the parking fee. The rider can pay the parking fee by credit card through the card reader (43) or inserting coin(s) into the slot device (42). Lastly, the central process unit (41) operates the drive device (20) to make the suitable drive device (40) drives the latch (30) into the housing (10) and then the rider can take back his/her bicycle.

As described above, the bicycle security apparatus in accordance with the present invention includes the following advantages.

1. Convenient: the rider does not need to carry a heavy lock and a key when riding bicycle outdoors. No more lock and key, the rider can ride the bicycle with a relaxed emotion. In addition, a problem of losing the key after lock the bicycle is disappeared.

2. The bicycle security apparatus in accordance with the present invention has a wide use scope because it can lock the top tube (A) or the down tube (B) of the bicycle. In addition, the operator only needs to move/lift and lock his/her bicycle when the height of the bicycle is not suitable to the bicycle security apparatus.

3. The user needs to ensure his/her identity before lock or unlock his/her bicycle such that a man with fraudulent intentions can not steal a bicycle from the bicycle security apparatus in accordance with the present invention. In addition, the rider does not take a wrong bicycle when the bicycles are similar to each other.

Although the invention has been explained in relation to its preferred embodiment, it is to be understood that many other possible modifications and variations can be made without departing from the spirit and scope of the invention as hereinafter claimed.

What is claimed is:

1. A bicycle security apparatus comprising:
a housing standing on a supporting plane, the housing including a panel formed on a front side thereof and two side plates respectively connected to the panel, at least one of the two side plates having an opening defined therein and a hook secured thereon, an opening defined in the side plate where the hook is secured, the hook having a distal end extending toward the opening;
at least one drive device disposed in the housing and corresponding to the at least one opening;
at least one latch connected to the at least one drive device and the at least one latch is reciprocally driven by the at least one drive device, wherein the latch is received in the housing when the bicycle security apparatus is in an unlocked condition and the latch facing the distal end of the hook when the bicycle security apparatus is in a locked condition; and
a control unit mounted onto the panel, the control unit including a central process unit mounted onto the interior of the panel, a slot device, a card reader and a fingerprint recognize device respectively mounted onto the panel and electrically connected to the central process unit, wherein the slot device is provided for user to insert coin(s) before take bake his/her bicycle and the card reader is provided to read the personal data from a card, and the card reader and the fingerprint recognize device are provided to recognize the person who wants to take back his/her bicycle, an input device disposed on the panel for user to input the pass word(s) of his/her card for ensuring the identity of the card owner.

2. The bicycle security apparatus as claimed in claim 1, wherein the housing has a partition horizontally mounted in the housing and the at least one drive device is mounted onto the partition.

3. The bicycle security apparatus as claimed in claim 1, wherein the at least one drive device includes a motor secured on the partition and a reducer longitudinally connected to the motor, the reducer having a shaft extending therefrom for mounting and reciprocally driving the latch within 90 degrees.

4. The bicycle security apparatus as claimed in claim 1, wherein:
each side plate of the housing includes an opening defined therein and the two openings horizontally correspond to each other;
each side plate of the housing includes a hook secured thereon and each hook has a free end extending toward a corresponding one of the two openings; and
two drive devices are respectively disposed in the housing and two latches are respectively connected to a corresponding one of the two drive device.

5. The bicycle security apparatus as claimed in claim 2, wherein the at least one drive device includes a motor secured on the partition and a reducer longitudinally connected to the motor, the reducer having a shaft extending therefrom for mounting and reciprocally driving the latch within 90 degrees.

6. The bicycle security apparatus as claimed in claim 2, wherein:
each side plate of the housing includes an opening defined therein and the two openings horizontally correspond to each other;
each side plate of the housing includes a hook secured thereon and each hook has a free end extending toward a corresponding one of the two openings; and
two drive devices are respectively mounted onto the partition and two latches are respectively connected to a corresponding one of the two drive device.

7. The bicycle security apparatus as claimed in claim 4, wherein each drive device includes a motor secured on the partition and a reducer longitudinally connected to the motor, the reducer having a shaft extending therefrom for mounting and reciprocally driving the latch within 90 degrees.

8. The bicycle security apparatus as claimed in claim 6, wherein the at least one drive device includes a motor secured on the partition and a reducer longitudinally connected to the motor, the reducer having a shaft extending therefrom for mounting and reciprocally driving the latch within 90 degrees.

9. The bicycle security apparatus as claimed in claim 4, wherein the control unit includes two selectors disposed on the panel and electrically connected to the central process unit, the selectors provided for user to select a corresponding one of the two drive devices which he/she wants to operate and lock/unlock his/her bicycle.

10. The bicycle security apparatus as claimed in claim 6, wherein the control unit includes two selectors disposed on the panel and electrically connected to the central process unit, the selectors provided for user to select a corresponding one of the two drive devices which he/she wants to operate and lock/unlock his/her bicycle.

11. The bicycle security apparatus as claimed in claim 7, wherein the control unit includes two selectors disposed on the panel and electrically connected to the central process unit, the selectors provided for user to select a corresponding one of the two drive devices which he/she wants to operate and lock/unlock his/her bicycle.

12. The bicycle security apparatus as claimed in claim 8, wherein the control unit includes two selectors disposed on the panel and electrically connected to the central process unit, the selectors provided for user to select a corresponding one of the two drive devices which he/she wants to operate and lock/unlock his/her bicycle.
